(19) United States
(12) Patent Application Publication
(10) Pub. No.: US 2007/0052540 A1
(43) Pub. Date: Mar. 8, 2007

(54) Sensor fusion for RFID accuracy

(75) Inventors: Kenwood H. Hall, Hudson, OH (US); Ramdas M. Pai, Racine, WI (US)

Correspondence Address: ROCKWELL AUTOMATION, INC./(AT), ATTENTION: SUSAN M. DONAHUE, 1201 SOUTH SECOND STREET, MILWAUKEE, WI, 53204, US

(73) Assignee: Rockwell Automation Technologies, Inc., Mayfield Heights, OH (US)

(21) Appl. No.: 11/220,130

(22) Filed: Sep. 6, 2005

(51) Int. Cl. G08B 13/14

(52) U.S. Cl. 340/572.1

(57) ABSTRACT

System(s) and method(s) to increase the accuracy and efficiency of an RFID system is provided. A system includes an RFID tag that receives a signal from an RFID reader and an RFID tag that receives a signal from an RFID reader. The system further includes at least one sensor that detects the environment of a product associated with the RFID tag and transmits a environment detection signal to the RFID reader; and an aggregation component that receives the environment detection signal and a corresponding data tag information from the RFID tag. If a environment detection signal is not received, the RFID reader ignores the data tag information.

### TECHNICAL FIELD

The following description relates generally to radio frequency identification (RFID) systems and more specifically, to systems and methods that improve accuracy and increase efficiency of RFID systems.

### BACKGROUND OF THE INVENTION

Radio frequency identification (RFID) technology leverages electronic data and wireless communication for identification purposes. With RFID systems, electronic data typically is stored within an RFID tag, which can be formed from a small silicon chip and one or more antennas, and affixed to a product. Reading from and/or writing to an RFID tag can be achieved through radio frequency (RF) based wireless communications via devices referred to as RFID readers. In general, writing is utilized to add and/or modify product-specific information to an RFID tag, and reading is utilized to retrieve the information, for example, to provide for automatic product identification. In many instances, the electronic data written to and/or read from an RFID tag includes an Electronic Product Code (EPC), which, in general, is a unique number that is encoded (e.g., as a bit code) and embedded within the RFID tag. Typical EPC data can include information about the associated product (e.g., product type, date of manufacture, lot number, . . . ) and/or associated pallets, boxes, cases and/or container levels, for example.

When passed through or scanned by a reader, an RFID tag emits stored electronic data such that the data can be retrieved by an RFID reader without unpacking the product or scanning barcode labels. Read information can be utilized to provide a greater degree of certainty over what goes into a supply chain and/or how to manage raw materials, warehouse inventory, shipments, logistics, and/or various other aspects of manufacturing.

A challenge associated with RFID technology is the reading of tags that are near the reader but not intended to be read. Tags on objects near the reader respond to a signal from the RFID reader, even if those tags are simply being moved throughout a warehouse from one location to another. Accordingly, there is an unmet need in the art for an improved RFID system to increase system accuracy and efficiency.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

A radio frequency identification (RFID) system that includes an RFID tag that sends a data tag information to an RFID reader. The system further includes at least one sensor that detects the location of a product associated with the RFID tag and transmits a location signal to the RFID reader and an aggregation component that receives the location signal and corresponding data tag information from the RFID tag. The location of the product is sensed by at least one of weight and presence of the product. The RFID reader only accepts the data tag information if an associated presence detection signal is received. According to another embodiment, the system includes a tracking component that maintains data tag information. The tracking component ignores duplicate data tag information.

According to another aspect is an RFID system that includes an RFID reader that broadcasts a signal to an RFID tag of an item and communicates a response signal from the RFID tag to a controller. The system further includes a sensor component that detects a presence of the item and sends to the controller a presence signal that corresponds to a location of the item. The controller processes the response signal from the RFID tag if the presence signal is received from the sensor component. The controller rejects the response signal from the RFID tag if the presence signal is received from the sensor component. According to another aspect the RFID reader further comprises a tracking component that records the response signal received from the RFID tag and discriminates the response signal from a second response signal received from a second RFID tag.

According to still another aspect is a method of invalidating an RFID read operation. The method includes sensing a location of an object to generate location data and receiving RFID tag data of the object. The location data and the RFID tag data are compared and the RFID tag data is processed accordingly. The method can also include accepting the RFID tag data if the location data indicates that the object should be read or rejecting the RFID tag data if the location data indicates that the object should not be read. According to another aspect, the RFID tag data and an RFID reader ID can be automatically transmitted if the location data indicates the object should be read. According to another aspect, the RFID tag data can be stored for further processing. A determination can be made if a subsequent received RFID tag data is the same as the stored RFID tag data and the subsequent received RFID tag data can be accepted or rejected.

In yet another aspect of the subject invention, an artificial intelligence component is provided that employs a probabilistic and/or statistical-based analysis to prognose or infer an action that is to be automatically performed.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates an RFID system that employs sensor fusion in accordance with an aspect of the invention.

FIG. 2 illustrates an RFID system that employs multiple sensors to increase tag read accuracy.

FIG. 3 illustrates an RFID system that employs different sensors that are read in conjunction with an RFID tag.

FIG. 4 illustrates an RFID system that employs artificial intelligence to facilitate automating one or more features in accordance with the subject invention.

FIG. 5 illustrates a methodology utilizing sensor fusion to enhance accuracy of an RFID system.

FIG. 6 illustrates another embodiment of a methodology of increasing RFID accuracy.

FIG. 7 illustrates an application of an RFID system in accordance with at least one aspect of the invention.

FIG. 8 illustrates a block diagram of a computer operable to execute the disclosed architecture.

FIG. 9 illustrates a schematic block diagram of an exemplary computing environment in accordance with the subject invention.

### DESCRIPTION OF THE INVENTION

The invention is now described with reference to the drawings, wherein like reference numerals are used to refer to like elements throughout. In the following description, for purposes of explanation, numerous specific details are set forth in order to provide a thorough understanding of the subject invention. It may be evident, however, that the invention can be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

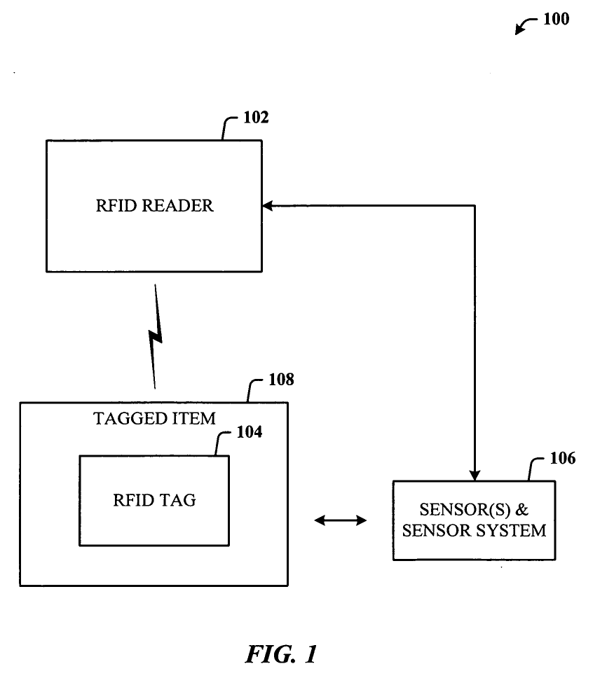

FIG. 1 illustrates an embodiment of an RFID system 100 that incorporates at least one sensor to increase read system accuracy and to measure the environment. RFID system 100 includes an RFID reader 102 that interfaces with at least one RFID tag 104 of a tagged item 108 via wireless communication. The RFID reader 102 can be various components that read, write, receive, and/or store electronic product data, such as, readers, writers and/or servers, and can be a handheld device or a fixed-mount device depending on the particular application. The RFID reader 102 can broadcast a signal or radio waves via an antenna or a plurality of antennas (not shown). The RFID reader 102 is operative to transmit a signal to an RFID tag 104, in response to which the tag 104 replies with tag data. Upon receiving the signal, the RFID tag 104 transmits a reply signal that is sent to and received by the RFID reader 102. The RFID tag 104 can be an active or passive RFID tag.

RFID reader 102 also interfaces with at least one sensor 106 that can utilize various types of auxiliary means to sense the presence of a product that is in the range of the RFID reader. RFID tag(s) 104 that respond to a signal from the RFID reader 102 but whose presence is not detected by the sensor 106 will be disregarded by the RFID reader 102. Thus, the accuracy of the RFID system 100 is improved because extraneous tags are ignored and not included in the RFID reader data.

The antenna for any particular device may be of any type suitable for use in a wireless communications system, such as a dipole antenna, a yagi-type antenna, etc. The coverage area or signal range of the RFID reader 102 can be anywhere from about one inch to about one hundred feet or more, depending upon the radio frequency used and the power output. The frequency range of the RFID system 100 can be a low-frequency range (e.g., from about 30 KHz to about 500 KHz), an intermediate-frequency range (e.g., about 10 MHz to about 15 MHz) or a high-frequency range, (e.g., from about 850 MHz to about 950 MHz and about 2.4 GHz and above). Higher frequency ranges offer longer read ranges (e.g., about 90 feet or more) and higher reading speeds. The signal can be continuously transmitted or periodically transmitted, such as when activated by an environmental sensor device.

The bidirectional signal transmission operates in a similar manner for both passive and active tags. Active RFID tags contain an internal battery or other suitable power source and are typically read/write devices. That is to say, the tag data can be rewritten and/or modified. The memory size of an active tag varies depending on the application requirements and, since it is powered onboard, it generally has a longer or wider read range or coverage area than a passive tag. Passive tags do not have an internal power source and obtain power generated by a reader. Passive tags can be read/wire devices or read-only devices. A read-only tag is generally programmed with a unique set of data that, in one implementation, cannot be modified, and in another implementation, can be modified. The main difference between an active device and a passive device is the signal range. Passive tags are limited to a few meters because the RFID reader 102 supplies the power to the tag via RF and is the only power supplied to the tag. Active tags can be read over hundreds of meters because they have an internal power supply. An example of a passive tag is a tag on a box of detergent in a department store. An active tag can be utilized, for example, at tollbooths on the turnpike to determine which car is passing through the booth for later billing purposes.

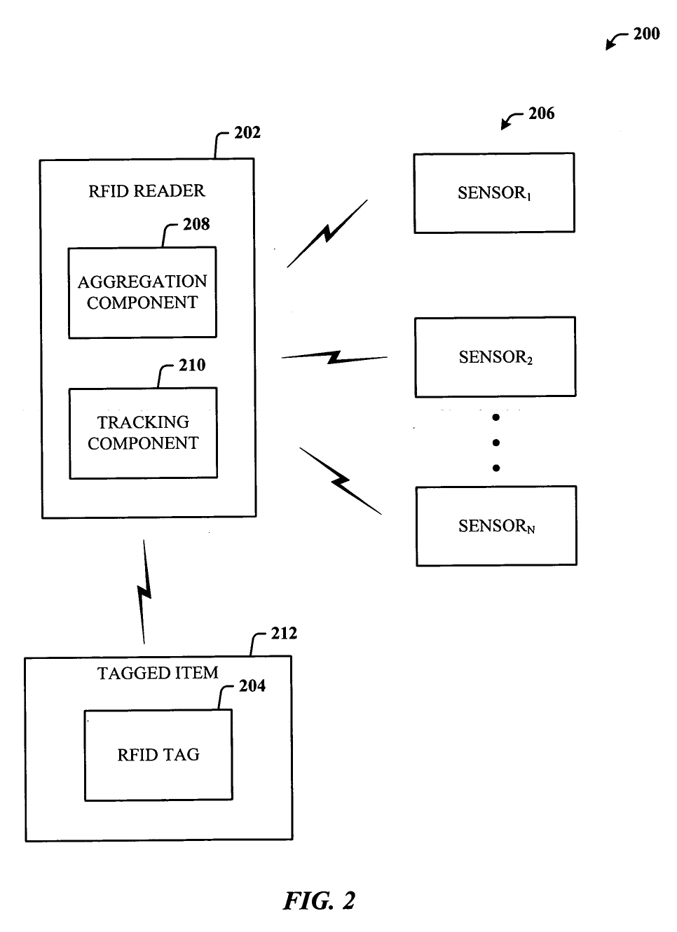

FIG. 2 illustrates an RFID system 200 employing multiple sensors to increase tag read accuracy. System 200 includes an RFID reader 202, at least one RFID tag 204 associated with a tagged item 212, and a plurality of sensors 206. There can be from one to N sensors, denoted Sensor₁,Sensor₂, . . . ,Sensor_{N}, where N is an integer equal to or greater than one. By combining or associating sensor data of the sensor(s) 206 with the data from RFID tag 204 the accuracy of the RFID reader 202 read operation is enhanced. For example, the sensor(s) 206 can include proximity sensor(s), ultrasonic sensor(s), photo eye(s), weight detector(s), pressure sensors, humidity sensors, and contact switches, etc. When an object, item, or product is detected by one or more of the sensors 206, a presence signal is sent to the RFID component 202 and/or a system associated therewith.

Interfaced to the RFID reader 202 is an aggregation component 208 and a tracking component 210. The aggregation component 208 receives, for example, a presence signal from at least one of the sensors 206 and anticipates receiving associated tag data from the RFID tag 204. Once the tag data has been read, the RFID reader 202 will not read another RFID tag 204 until another presence detection signal is received from the one or more sensors 206. However, it is to be appreciated that multiple reads can be performed on the same tag to increase confidence in the read operation. As a further way of obtaining confidence in a read operation, data associated with the health of the sensor can be provided to determine if the sensor is on line.

If a signal is received from the RFID tag 204 and there is not an associated signal from at least one of the sensors 206, then this can indicate that a tag has been read that should not have been read and the RFID component 202 will not accept the RFID tag 204 signal. This type of situation can occur where there are products being moved in a warehouse and only a specific subset of products are to be analyzed. By employing an RFID tag 204 in conjunction with at least one of the sensors 206 (sensor fusion) readings of products that are not within the subset of products to be read can be disregarded. This increases efficiency and accuracy of the system 200 by eliminating false reads that can occur in many industrial environments. Thus, requiring the presence of an object detected by at least one of the sensors 206 mitigates confusion caused when the RFID reader 202 reads RFID tags that are near but not intended to be read.

The tracking component 210 can receive and store a listing of the RFID tag data, such as in a controller of the RFID reader 202. The listing of previously read RFID tag(s) 204 allows the RFID reader 202 to distinguish between a new or current RFID tag and an RFID tag whose data has already been communicated to the RFID reader 202. This improves efficiency by allowing the RFID reader 202 to quickly distinguish and disregard or ignore multiple reads of the same RFID tag 204.

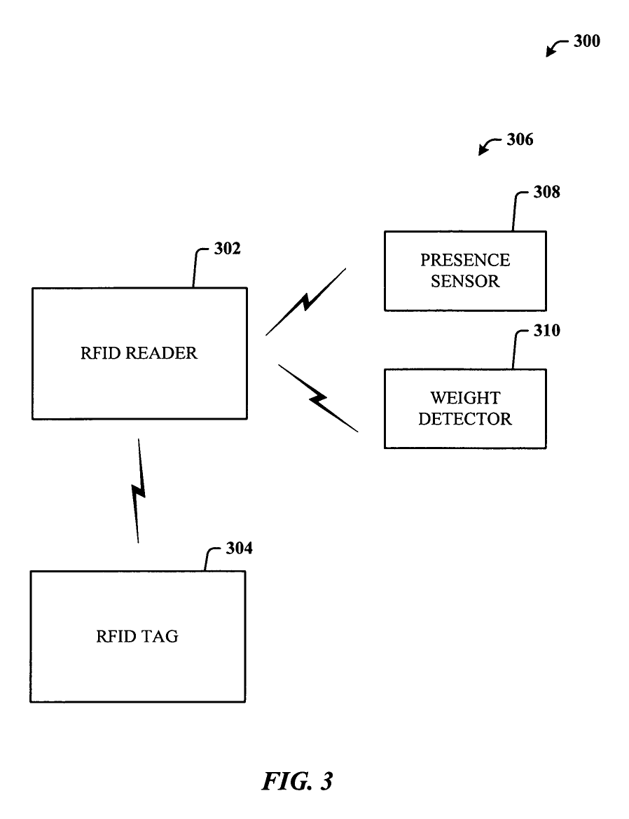

Referring now to FIG. 3, illustrated is an RFID system that employs different sensors that are read in conjunction with an RFID tag. The RFID reader 302 sends a signal to detect a plurality of RFID tags (of which one is illustrated at 304). At about the same time that the RFID reader 302 is requesting and receiving tag 304 data, a plurality of sensors 306 are obtaining data and communicating such data to the RFID reader 302. Illustrated are a presence sensor 308 and a weight detector 310. Presence sensors can be, for example, photo-eyes, mechanical switches, capacitive sensors, or vision systems.

The presence sensor 308 can be positioned along a conveyor belt, for example, to detect the presence of an object on the conveyor belt. The presence sensor 308, having sensed the object, communicates the presence of an object to the RFID reader 302. It is to be appreciated that the presence sensor 308 does not distinguish objects, it only detects the presence of an object. Once a presence detection is received, the RFID reader 302 will allow an RFID tag 304 to be read.

A weight detector 310 can also be associated with the conveyor belt to sense the presence of an object based upon the weight exerted on the conveyor belt. The weight detector 310 senses the presence of a tagged object based upon an associated weight. If there is a reading of approximately the predetermined weight of an expected object, the weight detector 310 sends a presence signal to the RFID reader 302. The RFID tag 304 will then be read.

When the RFID reader 302 receives a signal from either the presence sensor 308, the weight detector 310, or both, the RFID reader 302 anticipates a signal from at least one RFID tag 304. If a signal from an RFID tag 304 is not received, the RFID reader 302 can indicate a read failure, which may indicate a problem with the presence sensor 308, weight detector 310, RFID tag 304, or other parameters associated with the system 300. It may also indicate that a product associated with the RFID tag 304 has been removed (e.g., stolen) from the conveyor belt. If the RFID reader 302 does not receive a signal from either the presence sensor 308, weight detector 310, or both, any signals received from an RFID tag 304 are disregarded. It is to be understood that any combination of sensor can be utilized and the combination of FIG. 3 is for illustration purposes and any modifications and/or alterations are intended to fall within the subject disclosure and appended claims. For example, it is within the contemplation of the subject invention that the environment can be a vertical gravity drop system. In such a system the tagged product is dropped past the reader system and sensors facilitate detection and read accuracy.

In some situations, it might be necessary to detect and validate the presence of a single object on the conveyor belt with subsequent objects placed or spaced at a predetermined distance from each other. If two or more objects come into contact with each other or are so close together that both are read by the RFID reader 302 at substantially the same time due to a delay in movement of one or more objects (or due to other factors), the system 300 can detect that the objects are in close proximity to each other. The distance between the objects may be large enough that the presence sensor(s) 308 can detect both objects, but the RFID reader 302 should still be able to sort out which RFID tag 304 is in front of the RFID reader 302. This can be accomplished by controlling conveyor sections using the RFID tag(s) 304 in conjunction with sensing objects, such as presence sensor(s) 308 and/or weight detector(s) 310. These additional sensors can be placed at one or more designated stations along the conveyor belt. If the RFID reader 302 receives a signal from the presence sensor 308 and/or the weight detector 310 that indicates the presence of two or more objects close together (e.g., weight detected is the weight of two or more objects, time of a presence detected indicates more than one object), the RFID reader 302 can identify the signals received from the RFID tags 304 that are in close proximity to each other and adjustments can be made to the system 300. This may also indicate a potential problem with parameters associated with the system 300.

The RFID tag 304 and sensing objects, such as presence sensor(s) 308 and/or weight detector(s) 310 can also be utilized to determine appropriate spacing between objects and when to place another object on the conveyor belt. For example, the RFID reader 302 can receive a signal from the presence sensor 308 and/or weight detector 310 and also receive a signal from an associated RFID tag 304. A subsequent presence sensor 308 and/or weight detector 310 can be placed at a designated station that the object should pass before another object is placed on the conveyor belt. When a signal is received from the subsequent presence sensor 308 and/or weight detector 310, it can indicate that it is safe to place a next object on the conveyor belt, thus maintaining a safe distance between the objects.

According to another embodiment, index conveyors can be utilized to control the number of objects in the range of the RFID reader 302. The object could be moved one at a time to the RFID reader 302 using the presence sensor 308 to control the conveyor. After reading the RFID tag 304, the object can be moved a distance away so it is out of the range of the reader. In this manner, a correct read would read the RFID tag 304 and then would not read the RFID tag 304 when it is moved a far enough distance away from the RFID reader 302.

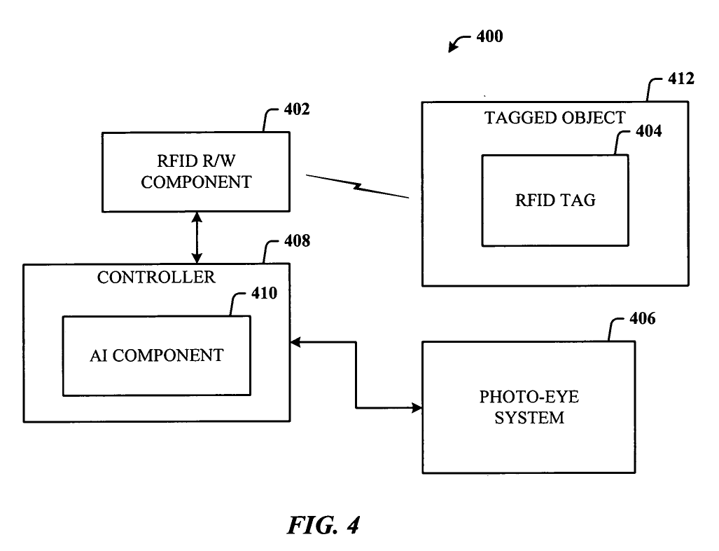

FIG. 4 illustrates an RFID system 400 that includes a tagged object 412 that has an RFID tag 404 and a photo eye 406 that interface with an RFID R/W component 402 and a controller 408 (e.g., a programmable logic controller-PLC). The controller 408 can be that which is typically utilized in a manufacturing, distribution, sales or any similar environment where products (or objects) are tagged with an RFID tag and logistically managed. In highly automated environments, PLCs (or other types of industrial controllers) are typically utilized in crates and/or chassis (not shown) that are in rack mount configurations at selected locations throughout the environment with additional modules employed therein for applications such as discrete I/O, power, communications, etc.

For purposes of illustration and not limitation, an RFID reader that is intended to track product on a conveyor line can be combined with one or more presence sensor, such as a photo eye, on the line wherein the photo eye(s) detect the presence of an object. While FIG. 4 illustrates a photo eye 406, it is to be understood that any type of sensor that detects the presence or absence of an object will work equally well in accordance with the subject disclosure.

An RFID reader may read the same tag multiple times as it approaches, moves past, and moves away therefrom. The logic in the RFID component 402 can be programmed to only accept RFID tag reads when a package is also detected by the photo eye 406. In other words, the photo eye 406 can detect the presence of a product and communicate to the controller 408 and/or RFID tag 404 an object present signal. The detection component 404 sends a signal to the controller 408 and/or photo eye 406, wherein such signal conveys product information. The controller 408 will only accept the signal from the RFID tag 404 if it has already received a signal from the photo eye 406 indicating the presence of an object. In such a way, readings of tags near the conveyor line, but not intended to be read, can be determined and such irrelevant readings disregarded. The overall bandwidth requirements will be reduced because the PLC will not send repeated or irrelevant RFID tag information to any host systems. The logic in the controller 408 can also monitor and track RFIDs on the conveyor to remember the last few tag reads. This enables the system 400 to distinguish between the current package and previous packages, further mitigating duplicate reads.

By using a combination of sensors with logic in a PLC, the accuracy of the RFID reads is enhanced. Failure to read an RFID tag will be detected because the sensor or photo eye, having already detected the package, signals the system 400 that a corresponding tag read should also occur. Use of sensor fusion increases the capability of the system 400 to know that all tags have been read and that undesired or irrelevant tags have not been mistakenly read.

The use of sensor fusion increases system performance because it allows cross-checking between the RFID reader and any other sensors so that a failure in either reader and/or sensors can be detected. In such a way, faster diagnosis of a problem and faster repair is enhanced. Moreover, the system 400, if programmed to do so, could continue to operate in a degraded mode using only the remaining working sensor(s) and/or reader.

With continuing reference to FIG. 4, the RFID system 400 can further employ artificial intelligence (Al) which facilitates automating one or more features in accordance with the subject invention. In this implementation, the controller 408 hosts an Al component 410, which can monitor signals and data of the controller 408, and processes of the internal RFID R/W component 402.

The subject invention (e.g., in connection with selection) can employ various AI-based schemes for carrying out various aspects thereof. For example, a process for improving the accuracy of the RFID system 400 can be facilitated via an automatic classifier system and process. Moreover, where a plurality of reader/writers 402 are employed, the classifier can be employed to determine which RFID reader/writer to adjust for improved accuracy and/or determine which RFID tags have been read and which require further reading.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or a training phase within a classifier constructor and feature selection module. Thus, the classifier(s) can be used to automatically learn and perform a number of functions, including but not limited to determining according to a predetermined criteria when to adjust the antenna and/or signal strength of an RFID reader/writer or when to rescan an area to find RFID tags that have not been read by the RFID reader/writer, for example.

In another implementation, the AI component 410 can receive assembly line or conveyor line speed data such it can “expect” an object or product to trigger the photo eye within a certain span (or window) of time. If the object does not “appear” in the expected time window, or a number of reactionary processes can occur: the line can be slowed until objects again begin to appear within the allotted time window, and then the line speed increased accordingly for optimum throughput. That is, the Al component 410 facilitates learning and controlling spatial and temporal attributes of the system 400 according to a given application.

In another application, the Al component 410 can be employed to learn and control line speed based on the capabilities of the controller 408 and R/W component 402 to read and process RFID data at the line speed. For example, if the line speed is such that RFID data processes is increasingly burdening the controller processor, the AI component 410 can, for example, reduce the line speed until such time as the controller processor attains stability. This can be automatically learned and adjusted for products of different sizes on the line. In other words, if product packing varies in size, this can lead to different spatial aspects of the products on the line. Accordingly, the AI component 410 can learn the spacing based in part on the RFID read and process capabilities of the controller, and automatically adjust the line accordingly, or transmit an alert that the line is experiencing or is about to experience a problem in throughput.

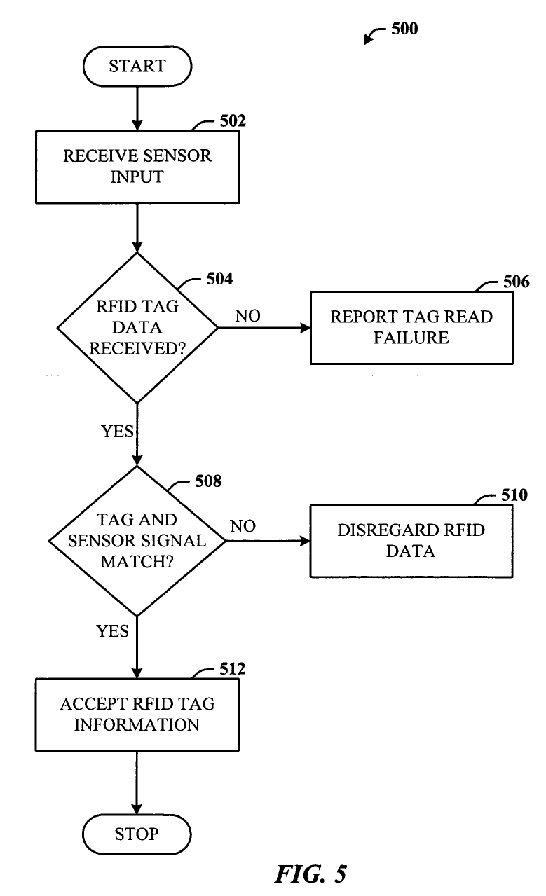

FIG. 5 illustrates a methodology 500 of utilizing sensor fusion to enhance accuracy of an RFID system. While, for purposes of simplicity of explanation, the one or more methodologies shown herein, e.g., in the form of a flow chart or flow diagram, are shown and described as a series of acts, it is to be understood and appreciated that the subject invention is not limited by the order of acts, as some acts may, in accordance with the invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the invention.

The method starts at 502, when a sensor signal is received by a RFID component, such as an RFID R/W device and/or controller. The sensor signal indicates the presence of a product, such as a product on a conveyor line, and indicates the presence of product(s) from which RFID tag data is required.

At 504, a determination is made if data from an RFID tag is read and/or received by an RFID R/W device. For example, the RFID tag may send the data to the RFID R/W device based upon a request by the RFID R/W device for the data, and/or it may be sent autonomously by the RFID tag periodically, continuously, or when it senses the presence of an RFID R/W device. If RFID tag data is not received, at 506, a tag read failure is reported and output to an operator indicating that the presence of a product was received, at 502, but there was a failure to read the tag. The operator can then determine required action, such as physically locating the part, slowing down a conveyor line if the failure to read is because the products are moving too fast, etc.

If the RFID tag information was received, at 504, the method continues at 508, and a determination is made whether the received RFID tag information matches the presence detection input. If there is no corresponding presence input, then the RFID tag information can be disregarded by the RFID R/W device, as indicated at 510. That is to say, the RFID tag that sent a signal is not a tag from the subset of products desired to be read. If there is a match, the RFID R/W device accepts the RFID tag signal, at 512, and continued processing can occur. The method can continue at 502 where a subsequent sensor input is received.

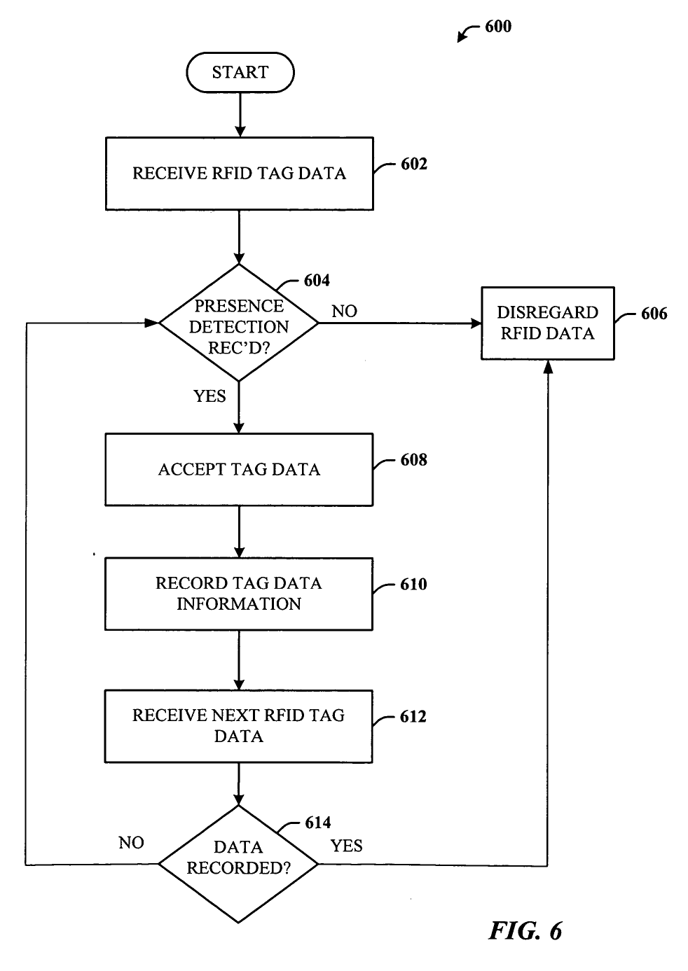

Referring now to FIG. 6 illustrated is a methodology 600 for enhancing performance of an RFID system. The method starts at 602 with RFID tag data received at an RFID R/W device. The data is sent from the RFID tag in response to a signal broadcast from the RFID R/W device. The broadcast signal can be continuous (e.g., when a series of data is to be read and/or written), or it can be periodic (e.g., time-based or sensor-based), for example.

A determination is made, at 604, whether a presence detection signal has been received at the controller indicating that there is at least one product in a subset of products that is to be read. If there is no associated signal, then it is an indication that RFID tags are responding to the RFID R/W device that are not part of the subset and, at 606, the data from those RFID tags is disregarded by the controller. If the determination, at 604, is “Yes”, then the RFID tag data is accepted by the controller 608. The tag data is then recorded or stored in the controller at 610.

The RFID R/W device sends another signal and receives RFID tag data of a next item at 612. A determination is made at 614 if the tag data was previously recorded or stored at 610. If “Yes”, it indicates that the particular RFID tag has been read and the tag information is disregarded, mitigating multiple reads. If the RFID tag data was not recorded, the method returns to 604 to determine if a presence detection signal has been received. The method continues until all RFID tags have been read and recorded.

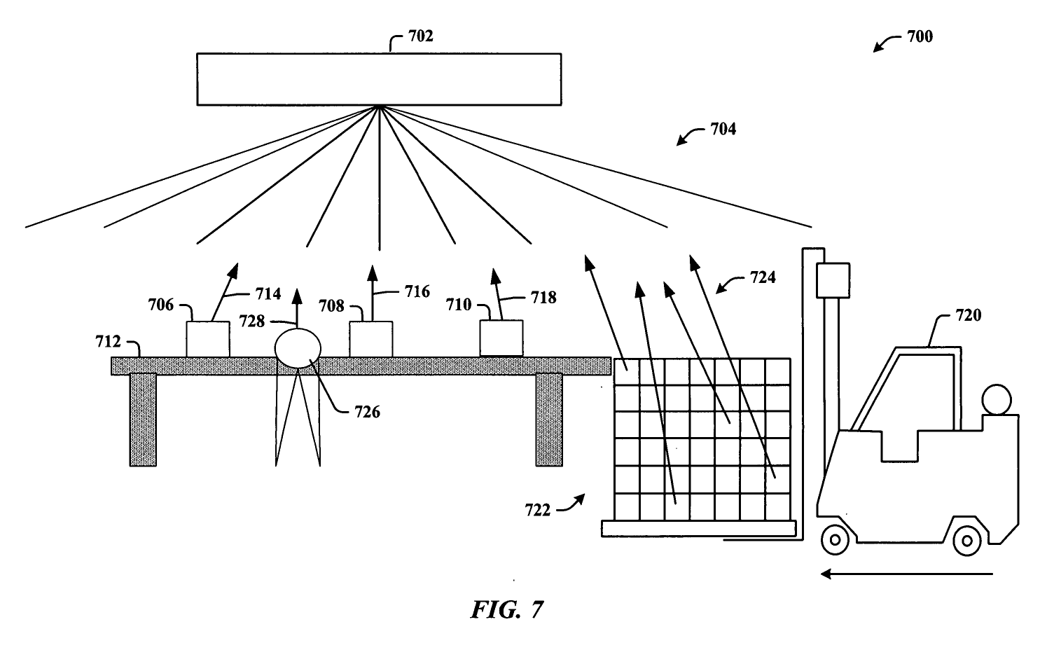

FIG. 7 illustrates an application of an RFID system in accordance with at least one aspect of the invention. An RFID reader 702 or a plurality of such readers can be placed in a plurality of locations in a warehouse, factory, store, etc. While one RFID reader 702 is illustrated it is to be appreciated that more than one RFID reader 702 can be utilized in accordance with the systems and/or methodologies disclosed herein.

The RFID reader 702 can be various components that read, write, receive, and/or store electronic product data, such as, readers, writers and/or servers, and can be a handheld device or a fixed-mount device depending on the particular application. The RFID reader 702 can broadcast a signal or radio waves 704 via an antenna or a plurality of antennas (not shown). The antenna for any particular device may be of any type suitable for use in a wireless communications system, such as a dipole antenna, a yagi-type antenna, etc. The coverage area or signal range of the RFID reader 702 can be anywhere from about one inch to about one hundred feet or more, depending upon the radio frequency used and the power output. The frequency range of the RFID system 700 can be a low-frequency range (e.g., from about 30 KHz to about 500 KHz), an intermediate-frequency range (e.g., about 10 MHz to about 15 MHz) or a high-frequency range, (e.g., from about 850 MHz to about 950 MHz and about 2.4 GHz to about 2.5 GHz). Higher frequency ranges offer longer read ranges (e.g., about 90 feet or more) and higher reading speeds. The signal can be continuously transmitted or periodically transmitted, such as when activated by a sensor device.

Products and associated RFID tags 706, 708, and 710 can be on a conveyor belt 712, for example, that moves the tagged product throughout the facility. The RFID tags 706, 708, 710 receive the RFID reader signal 704 and respond, as indicated at 714, 716, 718 respectively. There may also be products within range of the RFID reader 702 that are not intended to be read by the RFID reader 702. For example, a tow motor 720 may move a plurality of products and associated RFID tags 722 in close proximity to the conveyor belt 712 and within range of the RFID reader 702. The RFID tags associated with the plurality of product 722 receive the signal and respond, as indicated at 724.

In the absence of sensor fusion (as discussed above), the RFID reader 702 would receive the RFID signals 714, 716, 718, and 724 regardless of where the product is located in relation to the conveyor belt 712. This creates inaccurate data as well as system inefficiency. Therefore, a sensor such as a presence detector 726 is positioned so that the presence of product 706, 708, 710 intended to be read is detected by the sensor 726. Once the presence of an object is detected, the sensor 726 sends a signal 728 that is received by the RFID reader 702. The RFID reader anticipates a signal from an RFID tag that relates to the presence detection signal 728. The signal 728 can be communicated wirelessly and/or over a wired link. Additionally, the signal 728 can be routed to a controller or other system before arriving at the reader 702, or in lieu of the reader 702.

Thus, in operation, product 706 moves past the sensor 726 and a signal 728 is sent to the RFID reader 702. The RFID reader then anticipates the signal 714 from the product 706 that just passed the sensor 726. Signals 716, 718, and 724 from the plurality of other RFID tags 708, 710, and 722 is disregarded. In such a manner, the RFID reader 702 is not gathering erroneous data.

In addition, RFID reader 702 can include a means to track or record the tag data of tags it reads. For example, when RFID reader 702 receives the signal 714 from RFID tag 706, it retains the tag data. If RFID tag 706 sends a second signal 714, the RFID reader 702 acknowledges the signal 714 but disregards it as a duplicate read.

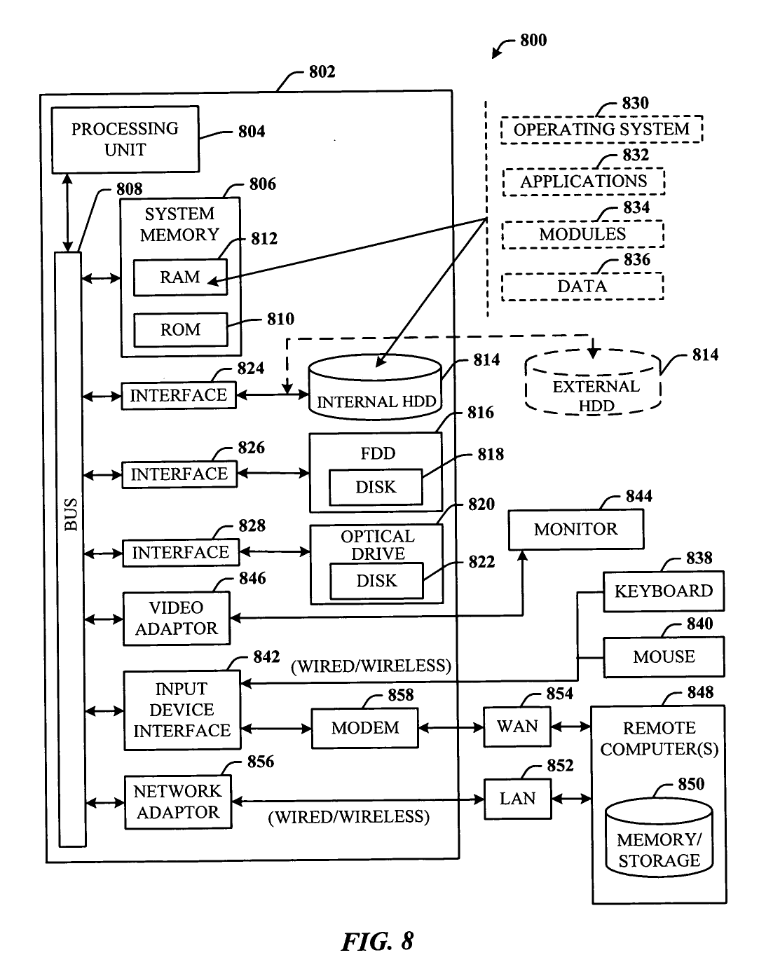

Referring now to FIG. 8, there is illustrated a block diagram of a computer operable to process signal strength data and generate a field mapping in accordance with the subject invention. In order to provide additional context for various aspects of the subject invention, FIG. 8 and the following discussion are intended to provide a brief, general description of a suitable computing environment 800 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 8, the exemplary environment 800 for implementing various aspects of the invention includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816, and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE 1394 interface technologies. Other external drive connection technologies are within contemplation of the subject invention.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 812, including an operating system 830, one or more application programs 832, other program modules 834, and program data 836. All or portions of the operating system, applications, modules, and/or data can also be cached in the RAM 812. It is appreciated that the invention can be implemented with various commercially available operating systems or combinations of operating systems.

A user can enter commands and information into the computer 802 through one or more wired/wireless input devices, e.g., a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE 1394 serial port, a game port, a USB port, an IR interface, etc.

A monitor 844 or other type of display device is also connected to the. system bus 808 via an interface, such as a video adapter 846. In addition to the monitor 844, a computer typically includes other peripheral output devices (not shown), such as speakers, printers, etc.

The computer 802 may operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device, or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adaptor 856 may facilitate wired or wireless communication to the LAN 852, which may also include a wireless access point disposed thereon for communicating with the wireless adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

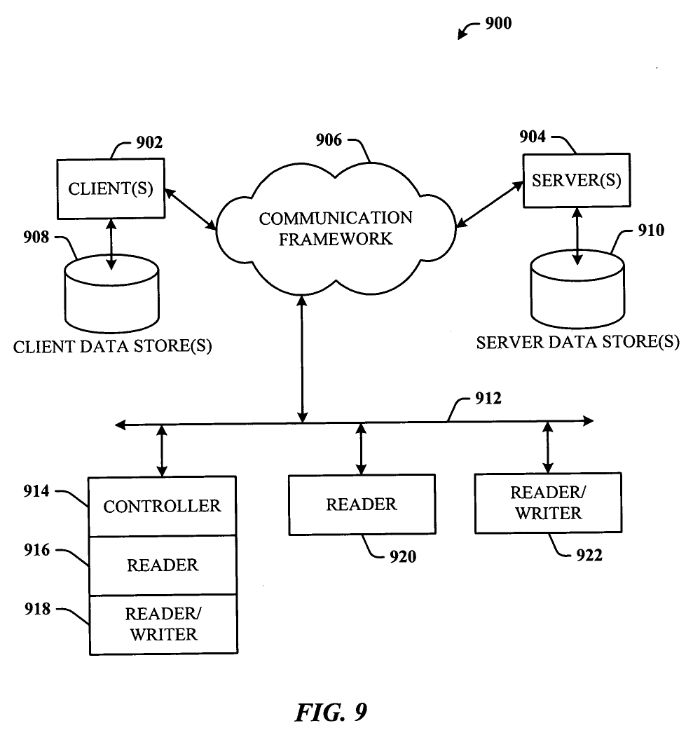

Referring now to FIG. 9, there is illustrated a schematic block diagram of an exemplary computing environment 900 in accordance with the subject invention. The system 900 includes one or more client(s) 902. The client(s) 902 can be hardware and/or software (e.g., threads, processes, computing devices). The client(s) 902 can house cookie(s) and/or associated contextual information by employing the invention, for example.

The system 900 also includes one or more server(s) 904. The server(s) 904 can also be hardware and/or software (e.g., threads, processes, computing devices). The servers 904 can house threads to perform transformations by employing the invention, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

The framework 906 can also include a subnetwork 912, for example, that can be implemented as in an assembly line environment. The subnetwork 912 can have disposed thereon as nodes, a controller 914 (e.g., a PLC) that controls a reader module 916 and a reader/writer module 918 both of which can read RFID tags, and the latter of which can write data to the RFID tags. The controller 914, reader module 916 and reader/writer module 918 can be provided in a rack configuration at selected locations. Alternatively or in combination therewith, the subnetwork 912 can also include a second reader module 920 as a wired or wireless node (or client) that is positioned (fixed or mobile) to read RFD tags, as needed. Similarly, the subnetwork 912 can also support a reader/writer module 922 as a wired and/or wireless client node for reading and writing data and signals to RIFD tags that come within a coverage area.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A radio frequency identification (RFID) system, comprising:
an RFID tag that sends a data tag information to an RFID reader;
at least one sensor that detects a location of a product associated with the RFID tag and transmits a location signal to the RFID reader; and
an aggregation component that receives the location signal and the corresponding data tag information from the RFID tag.

2. The system of claim 1, the location of a product is sensed by at least one of weight and presence of the product.

3. The system of claim 1, further comprising a tracking component that maintains the data tag information.

4. The system of claim 3, the tracking component ignores data tag information that is a duplicate of maintained data tag information.

5. The system of claim 1, the RFID reader only accepts the data tag information if an associated location detection signal is received.

6. The system of claim 1, wherein the RFID reader is also a writer that writes data to the RFID tag.

7. The system of claim 1, wherein the sensor includes a photo detection system.

8. The system of claim 1, wherein the sensor includes a weight detector.

9. The system of claim 1, further comprising an artificial intelligence component that employs a probabilistic and/or statistical-based analysis to prognose or infer an action to be automatically performed.

10. An RFID system, comprising:
an RFID reader that broadcasts a signal to an RFID tag of an item and communicates a response signal from the RFID tag to a controller; and
a sensor component that detects a presence of the item and sends to the controller a presence signal that corresponds to a location of the item.

11. The system of claim 10, wherein the controller processes the response signal from the RFID tag if the presence signal is received from the sensor component.

12. The system of claim 10, wherein the controller rejects the response signal from the RFID tag if the presence signal is not received from the sensor component.

13. The system of claim 10, wherein the RFID reader further comprises a tracking component that records the response signal received from the RFID tag and discriminates the response signal from a second response signal received from a second RFID tag.

14. The system of claim 10, wherein the controller tracks an RFID tag that has been read to distinguish between a current item and an item that includes the RFID tag that has been read.

15. The system of claim 10, wherein the sensor component includes a plurality of item detection systems that output signals based upon the location of the item.

16. The system of claim 15, wherein the output signals are processed in combination with the response signal to indicate status of an RFID read operation.

17. A method of validating an RFID read operation, comprising:
sensing a location of an object to generate location data;
receiving RFID tag data of the object;
comparing the location data and RFID tag data; and
processing the RFID tag data accordingly.

18. The method of claim 17, further comprising accepting the RFID tag data if the location data indicates that the object should be read.

19. The method of claim 17, further comprising rejecting the RFID tag data if the location data indicates that the object should not be read.

20. The method of claim 17, further comprising automatically transmitting the RFID tag data and an RFID reader ID if the location data indicates that the object should be read.

21. The method of claim 17, further comprising storing the RFID tag data for further processing.

22. The method of claim 21, further comprising determining if a subsequent received RFID tag data is same as the stored RFID tag data.

23. The method of claim 22, further comprising accepting the subsequent received RFID tag data when the received RFID tag data is different from the stored RFID tag data.

24. The method of claim 22, further comprising rejecting the received RFID tag data when the received RFID tag data is same as the stored RFID tag data.

25. The method of claim 17, further comprising tracking RFID tag data associated with past read operations to differentiate a current object from a past object that is associated with the past read operations.

26. A system that facilitates an RFID data read operation, comprising:
means for detecting location of an object;
means for receiving a presence signal associated with the location of the object;
means for activating a read operation of an RFID tag of the object;
means for receiving RFID tag data during a read operation of the RFID tag; and
means for processing the RFID tag data and the presence signal to determine a status of the read operation.

27. The system of claim 26, further comprising means for tracking the RFID tag data to distinguish between a current object and an object that includes the RFID tag that has been read.

28. The system of claim 26, wherein the means for processing the RFID tag data is performed by a controller.

29. The system of claim 26, wherein the location of the object is sensed by at least one of weight and presence of the object.

30. The system of claim 26, further comprising an artificial intelligence component that employs a probabilistic and/or statistical-based analysis to prognose or infer an action to be automatically performed.
